(19) United States
(12) Patent Application Publication
(10) Pub. No.: US 2008/0220146 A1
(43) Pub. Date: Sep. 11, 2008

(54) METHOD AND APPARATUS FOR PRODUCING COCOA PRODUCTS

(76) Inventor: Rene Frans deBoer, Purmerend (NL)

Correspondence Address: JESSE A. HIRSHMAN, ESQ., 1722 MURRAY AVENUE, THIRD FLOOR, PITTSBURGH, PA, 15217, US

(21) Appl. No.: 12/042,609

(22) Filed: Mar. 5, 2008

Related U.S. Application Data
(60) Provisional application No. 60/893,209, filed on Mar. 6, 2007.

(51) Int. Cl. A23G 1/56; A47J 43/04; F25D 31/00

(52) U.S. Cl. 426/631; 99/537; 62/320; 99/485

(57) ABSTRACT

Provided are processes for producing cocoa-containing compositions by comminution of cocoa beans and/or portions thereof, systems for carrying out such processes and products produced therefrom.

### CROSS REFERENCE TO RELATED APPLICATIONS

This application claims the benefit under 35 U.S.C. §119(e) to U.S. Provisional Patent Application No. 60/893,209, filed on Mar. 6, 2007, which is incorporated herein by reference in its entirety.

### TECHNICAL FIELD

Described herein are methods, process systems and apparatus useful in producing cocoa and products comprising cocoa.

### BACKGROUND

The way cocoa is processed determines the various qualities of the resulting chocolate or cocoa product, such as flavor, color, intensity, hardness and snap. Cocoa beans and/or portions thereof, typically are processed into chocolate liquor, also called cocoa liquor or cocoa mass, which in turn may be processed to form cocoa powder and cocoa butter. Chocolate liquor, cocoa powder and cocoa butter can then be used separately or mixed in various combinations to form various products containing cocoa.

A typical cocoa processing procedure begins with harvesting, fermenting and drying of the cocoa beans. Then, the cocoa beans are cleaned and roasted. The roasted beans are winnowed, wherein the shell and germ are separated from the cotyledon (or nib) of the cocoa bean to produce cocoa nibs, though some processes use the shell, too. The cocoa nibs can be alkalized, dried and roasted. The nibs are ground or otherwise comminuted, which ruptures the cell walls within the cocoa nibs and releases the cocoa fat. Due to the frictional heat of the grinding process, the cocoa fat is liquefied and chocolate liquor is formed. The chocolate liquor can be pressed to extract the cocoa butter, which comprises the cocoa fat, leaving a cocoa presscake. The cocoa butter can be further refined and treated. The cocoa presscake typically is broken, blended and ground to form cocoa powder.

Grinding of cocoa nibs (or other cocoa bean portions, including whole bean and shells) into chocolate liquor typically is performed in multiple steps, where a pre-grinding step crushes solid nibs into the chocolate liquor and sequential grinding steps reduce the size of the cocoa particles within the chocolate liquor.

Grinding can be performed in various types of mills or combinations thereof. For example, in one type of mill, a three stone mill, three pairs of horizontal discs are set in a tier. Within each pair, the lower stone is stationery while the upper stone rotates. The distance between the lower and upper stone controls the fineness of the grinding. The material, either nibs or partly ground chocolate liquor, is fed into the center of the stones. Grinding takes place as the material works its way to the periphery of the stone. In modern stone mills, the “stones” typically are carborundum (silicon carbide).

In a disc mill, grooved steel discs are arranged horizontally or vertically. For a vertical disc mill, a pair of steel discs is set vertically, where one disc is fixed and the other disc rotates. In a variation of a disc mill, one stationary steel disc can be placed between two rotating discs. For a horizontal disc mill, multiple fixed and rotating discs are used, where an outer pair of discs is fixed and the inner pair of discs rotates. Modern mills also have circulating water jackets to keep the fixed discs cool.

In a ball mill, grinding balls are enclosed within a cylinder and agitated by a rotor. The cylinder can have different zones, where each zone contains balls of decreasing diameter to produce finer particles within the chocolate liquor.

In yet another example, a pin mill or an impact mill can be used. In a pin mill, the material strikes multiple pins or impact structures on a rotor plate, where the material is driven from the center to the edges of a rotor plate by inertia.

To obtain higher quality cocoa products, cocoa particles typically are finely ground (comminuted) to an average size of approximately 40 μm (40 micrometers or microns (μ)) and a fineness at 75μ of about 99% (99% wt.). There are optimal conditions for mean or average particle size, distribution of the particle sizes and “fineness.” For monitoring of cocoa processes, fineness of the cocoa product is typically determined to show the lack of coarse particles. “Fineness” is typically determined by a standardized sieve residue method according to the International Confectionery Association. For example and without limitation, a cocoa powder with a fineness at 75μ of 99% has a coarseness of 1%, wherein 99% by mass of the particles can pass through a sieve with apertures of 75 μm by 75 μm and 1% by mass cannot pass through those apertures. Though fineness provides limited information about the distribution of the particle sizes, fineness does not provide information about the mean size of the particles, which can be defined by any means, such as, without limitation, by a peak of a curve for size distribution. For example and without limitation, a cocoa powder with a fineness at 75μ of 99% has 99% by mass of the particles smaller than 75 μm and 1% by mass of particles that are larger than 75 μm, but the mean particle size is unknown.

In the cocoa industry, sequences of multiple mills are used for comminuting cocoa particles in the chocolate liquor. This grinding process is energy intensive and requires frequent equipment maintenance. Changes in the grinding process, such as using different mills, can result in changes in the product, such as increased coarseness or reduced production of the chocolate liquor.

One difficulty in the comminution process is that cocoa beans are commonly contaminated with stones, which are hard to remove completely and which are becoming more prevalent. Typically, one of the mills in the sequence is a ball mill containing stainless steel balls of, for example, 5 mm in diameter. When cocoa beans are comminuted, the stones are broken up. When placed in a ball mill, the broken stones abrade the steel balls, releasing iron. Further, this abrasion requires the steel balls to be changed at least every 9 months. The flavor of cocoa can be affected by the presence of excess iron. Using a sequence of mills to process cocoa beans and/or portions thereof according to standard practices, the iron content is significant: approximately 250 ppm of iron for chocolate liquor.

### SUMMARY

According to one non-limiting embodiment of the technology described herein is a method of making a cocoa-containing composition. The method comprises comminuting cocoa beans in a mill at a temperature below a melting temperature of cocoa butter in the cocoa beans. The beans may comprise, without limitation whole cocoa beans, shelled cocoa beans, cocoa nibs, cocoa bean shells, cocoa bean embryos, cocoa bean cotyledons or combinations of any thereof, that can be roasted, unroasted or alkalized. In one embodiment, the cocoa beans substantially comprise (with other incidental constituents or impurities in acceptable quantities) cocoa nibs. The cocoa beans may be comminuted at 15° C. or less, less than about −20° C., or even cooler. The mill, and thus the beans may be cooled with air, liquid nitrogen, cooled nitrogen, liquid CO₂ or solid CO₂.

According to certain non-limiting embodiments, the cocoa beans are comminuted to a fineness at 75μ of at least about 99% or 99.5%. The mean particle size of the comminuted particles in the cocoa-containing composition is, according to certain non-limiting embodiments, less than about 40 μm, between 15 μm and 40 μm or approximately 20 μm. Through use of a classification mill as described herein, the beans can be comminuted to a fineness at 10 μm of less than 5% according to one non-limiting embodiment.

In one embodiment, the cocoa-containing composition is chocolate liquor. In another, the cocoa-containing composition is a chocolate dough comprising chocolate liquor and sugar, and optionally isolated or purified cocoa butter is added to the chocolate dough. The method may further comprise mixing the cocoa-containing composition in one or more of a beverage, a dough, a batter, a candy confection, a syrup, a chocolate flavoring, a vitamin, a drug product and a nutraceutical or herbal product. The method may further comprise packing and storing the cocoa-containing composition at a temperature below a melting temperature of cocoa butter in the composition and, optionally, shipping the cocoa-containing composition at a temperature below a melting temperature of cocoa butter in the composition.

In certain embodiments, the method comprises mixing the cocoa-containing composition with an amount of cocoa powder effective to produce a low-fat chocolate liquor having a fat content of lower than about 50%, for example and without limitation, at a temperature below a melting temperature of cocoa butter in the cocoa-containing composition.

Also provided herein is a system for producing a cocoa-containing composition from cocoa beans comprising a mill maintained at a temperature at which cocoa butter in cocoa beans is solid. According to one non-limiting embodiment, the mill is a hammer mill integrated with a classifier. The system may comprise a cooler configured into the system to cool the cocoa beans before the cocoa beans are fed into the mill. In one non-limiting embodiment, the mill comprises cocoa beans at a temperature at or below about 15° C. The components of the system may be contained a room maintained at a temperature below 15° C. in order to cool the system. In other non-limiting embodiments, the mill is cooled with liquid nitrogen or liquid CO₂. The system also may comprise a conche configured into the system or the system may be operatively connected to the conche such that the conche receives comminuted cocoa-containing composition, as well as, optionally, one or both of a mixing vessel and a refining roller configured into the system between the classification mill and the conche.

In another non-limiting embodiment, chocolate liquor is provided that is prepared according to a process comprising comminuting cocoa beans at a temperature below a melting temperature of cocoa butter in the cocoa beans. In one embodiment, the produced chocolate liquor has an iron content of less than about 200 ppm. According to certain embodiments, the cocoa-containing composition may comprise milk powder, additional cocoa powder, sugar, additional solid cocoa butter, flavorings, liquids, fragrances, sweeteners, colorings, rheology modifiers, solidified oils, surfactants, emulsifiers, vitamins, and combinations of any thereof. The chocolate liquor may comprise particles at a temperature below an average melting temperature of cocoa butter in the cocoa beans that have a fineness at 75μ of less that about 1%. In another non-limiting embodiment, the chocolate liquor comprises particles at a temperature below an average melting temperature of cocoa butter in the cocoa beans that have a fineness at 10μ of greater than about 10%.

### BRIEF DESCRIPTION OF THE FIGURES

FIG. 1 is a schematic diagram showing various non-limiting embodiments of a cocoa bean processing system described herein.

### DETAILED DESCRIPTION

The use of numerical values in the various ranges specified in this application, unless expressly indicated otherwise, are stated as approximations as though the minimum and maximum values within the stated ranges are both preceded by the word “about”, whether or not the term “about” is present. In this manner, slight variations above and below the stated ranges can be used to achieve substantially the same results as values within the ranges. Also, unless indicated otherwise, the disclosure of these ranges is intended as a continuous range including every value between the minimum and maximum values. For definitions provided herein, those definitions also refer to word forms, cognates and grammatical variants of those words or phrases.

As used herein, and unless indicated otherwise, “a” and/or “an” refer to one or more.

As used herein, “cocoa” includes cocoa beans or portions thereof, such as, without limitation, nibs (natural, raw, dried, roasted, un-fermented and/or alkalized), shells, unshelled beans, embryos, cotyledons, cocoa powder, cocoa butter, cocoa particles and/or any other product of cocoa bean processing. Cocoa can be further processed to yield, including, without limitation, chocolate liquor, cocoa butter, cocoa powder, and/or chocolate. As used herein, “cocoa beans” includes whole cocoa beans, shelled cocoa beans, nibs (natural, raw, dried, roasted, un-fermented and/or alkalized), shells, embryos, cotyledons or combinations thereof, whether roasted or unroasted.

As used herein, “chocolate liquor” is synonymous with cocoa liquor and includes a mixture of cocoa powder and cocoa butter that is obtained from grinding cocoa beans or portions thereof.

As used herein, a “cocoa-containing composition” includes a composition comprising one or more of, without limitation: comminuted cocoa beans, chocolate liquor, cocoa butter, cocoa powder, and/or any other products of cocoa bean processing. The cocoa-containing composition can comprise one or more other components, including, without limitation: milk and/or milk powder, sugar(s), non-nutritive sweeteners, flour(s), flavorings, colorants, rheology modifiers, preservative(s), vitamin(s), supplement(s), nutraceutical(s), herbal(s), food(s), nut(s), fruit(s), additive(s), stabilizer(s), emulsifying agent(s), protein(s), carbohydrate(s), oil(s), and any other ingredient(s). Cocoa-containing compositions include, without limitation: chocolate, dark chocolate, milk chocolate, chocolate confections, chocolate dough, dough, and chocolate paste. The cocoa-containing composition can be further processed to take any of a number of forms, including, without limitation, beverages, doughs, batter, bars, chips, shavings, liquids, solids, gels, creams, homogenates, suspensions and any food product prepared from cocoa and/or chocolate.

As used herein, the term “comminute” and any other word forms or cognates thereof, such as, without limitation, “comminution” and “comminuting”, includes the process of reducing a composition from a first size to a smaller size by any suitable method or process, including, without limitation, grinding, hammering, crushing, pulverizing, abrading and/or chopping. For example and without limitation, in the context of a technology described herein, comminution, as well as other word forms or cognates thereof, includes the reduction in size of cocoa beans or a portion thereof, such as nibs, shells, unshelled beans, embryos, cotyledons, cocoa particles, or combinations thereof, by grinding, hammering, crushing, pulverizing, abrading and/or chopping. In addition, for example and without limitation, in the context of a technology described herein, comminution, as well as other word forms or cognates thereof, includes the reduction in size of cocoa or cocoa particles within cocoa-containing compositions, such as chocolate liquor, chocolate dough, by grinding, hammering, crushing, pulverizing, abrading and/or chopping.

As used herein, “comminution temperature” includes the maximum temperature at which cocoa or cocoa-containing compositions are exposed to throughout the comminution process and the maximum temperature of the comminuted cocoa or cocoa-containing composition upon exiting the comminution process. In the context of the present disclosure, the comminution temperature typically is below the melting temperature of the cocoa butter stored within the cotyledon of the cocoa bean. Different polymorphs of the crystal structure of cocoa butter melt at different temperatures, wherein crystal form I has a melting point of ˜17° C. and crystal form VI has a melting point of ˜36° C. As cocoa butter typically comprises a combination of different polymorphs, the average melting temperature can be between 23° C. to 25° C. For example and without limitation, in the context of a technology described herein, the comminution temperature should be below 17° C., the highest comminution temperature should be at 15° C., the comminution temperature could be between 10° C. to 15° C.

As used herein, “fineness” of the cocoa-containing composition is expressed as 100% minus % sieve residue. The “% sieve residue” is defined as the mass percentage of the composition that does not pass through a sieve with apertures of a particular size. “Coarseness” is defined by the % sieve residue, where fineness is defined as 100% minus the % sieve residue. For example and without limitation, in the context of the methods and compositions described herein, a fineness at 75μ of chocolate liquor can be 99%, wherein about 1% by mass of the chocolate liquor does not pass through a sieve with apertures of 75 μm by 75 μm (±2 μm). For example and without limitation, in the context of the methods and compositions described herein, a fineness at 10μ of chocolate liquor can be less than 5%, wherein about 95% by mass of the chocolate liquor does not pass through a sieve with apertures of 10 μm by 10 μm.

As used herein, “mean particle size” is the average particle size within a distribution of particle sizes. Mean particle size can be determined by any statistically acceptable method and is not limited by any given statistical method.

As used herein, a “classification mill” includes a mill capable of comminuting particles and size-fractioning the comminuted particles as they are comminuted. A classification mill combines milling and simultaneous size fractioning, typically in a single apparatus, and therefore combines a mill and a classifier, typically in a single apparatus. A mill portion of a classification mill is any of a variety of mill types used for comminuting particles, including, without limitation, ball mills, blade mills, disc mills, hammer mills, impact mills, pin mills or combinations of any thereof. Particles are moved from the mill to the classifier (classification portion) by a flow of air that is pumped into the mill or by a vortex or cyclone of air that is created within the mill. The air sweeps the particles through the classifier, which can include, without limitation, rejector cages, sieves, filters, and/or rotating wheels, having vanes, blades or apertures of various geometries to separate comminuted particles depending on size. Examples of classifier mills include, without limitation, Hosokawa ACM2, Hosokawa Micron ACM 150 Air Classifier Mill, and Contraplex Cocoa Mill from Hosokawa Micron, Gmbh, Cologne, Germany; Micron-Air Classifier MS from Alpine; Turboplex®-Ultrafine Classifiers ATP and ATP-NG from Hosokawa Alpine, Augsburg, Germany; CSM Classifier Mill, CP Impact Mill and CFS Mechanical Air Classifier by Netzsch, Inc., Exton, Pa.; Sturtevant NSP Powderizer® from Sturtevant Inc., Hanover, Mass.; Duyvis-NEA ICM Impact Classifier Mill by Duyvis at Koog a/d Zaan, Netherlands; and Raymond® Hybrid Turbine Classifier™ from Alstom Power Inc., Paris France.

As used herein, a “system” includes an apparatus or a combination of apparatuses that achieves a specific goal. A non-limiting example of a system is a processing or manufacturing line comprising components required to carry out a desired process. For example and without limitation, a system for producing a cocoa-containing composition comprises an apparatus for production of the cocoa-containing composition.

As used herein, a “nib cooler” includes an apparatus that cools cocoa beans or portions thereof after roasting. Using ambient air or cooled air, the temperature of the cocoa beans or portions thereof is decreased, for example and without limitation, from 95° C. to about 60° C. Examples of nib coolers include, without limitation, Counterflow® coolers manufactured by Geelen Counterflow, The Netherlands, and Fluid Bed Drying/Cooling systems manufactured by Universal Milling Technologies and Andritz, The Netherlands.

In the cocoa industry, classification mills are sometimes used for comminuting cocoa powder, that is, chocolate liquor that has been pressed to remove cocoa butter. Classification of cocoa beans is problematic because without maintaining cryogenic temperatures in the classification mill (below the melting temperature of cocoa butter in the beans), the cocoa beans liquefy upon comminution into chocolate liquor, making classification impossible.

In a classification mill, particles are comminuted in a mill portion of the classification mill and the particles are separated by size in a classification portion of the classification mill. The mill portion and the classification portion of the classification mill are integrated, meaning that particles larger than a threshold size are recirculated from the classification portion to the mill portion for further comminution. In one non-limiting example of a classification mill, the mill portion is a pin mill and the classification portion is a rotating classifier wheel. In such a device, air flow transports particles comminuted in the pin mill to a rotating classifier wheel and only particles that are small enough to pass through apertures of the rotating wheel are collected for downstream use/processing. Larger particles retained by the classifier wheel are swept back into the mill portion where the larger particles are further comminuted by striking impact structures, and are again transported to the classifier wheel for separation. Classification mills can employ a variety of different methods for comminuting a material, using for the mill portion, for example and without limitation, a disc mill or a pin mill. Likewise, different devices can be used for the classification portion, for example and without limitation, a rotating blade or a stationary sieve.

One benefit of a classification mill having an integrated classifier is that particle size distribution is more tightly controlled as compared to systems with a fixed classifier (size separator, screen(s), sieve, etc.). This is due to the exclusion of particles below the classifier threshold size from further comminution. Thus, once a particle is reduced in size below a specific size, for example and without limitation, 75 μm, it is not broken down into smaller fragments because it is removed immediately for downstream use/processing. As a result, fewer particles much smaller than the classifier exclusion limit (for example and without limitation, smaller than about 15 μm) are produced.

In most applications, the fineness of cocoa powder (solids) in a chocolate liquor or cocoa-containing product is of major importance. The finer the powder, the smaller the individual particles and the greater the surface area of the powder will be. This can affect both flavor development and mouth-feel of a finished product. Very finely ground cocoa powder has a positive effect on the color intensity of the end-product, as well as on the viscosity of products such as syrups. Fine powders also show less tendency to settle out in liquid products.

Furthermore, the finer the powder, the more quickly the powder's effect becomes evident in the mouth and the less the powder can be detected as an ingredient by itself. In chocolate milk or milk-based desserts, for instance, the presence of a small amount of coarse particles can easily be noticed. The particles can be seen against the white background of the milk as brown specks and can adversely affect the smooth mouth-feel of the product.

Nevertheless, significant amounts of extra fine particles (less than about 15 μm) also are undesirable. The presence of the extra fine particles greatly increases the viscosity of the cocoa product to undesirable levels, and agglomeration becomes an issue with finer powders. In either case, the presence of significant amounts of too-coarse or too-fine particles in a chocolate liquor results in increased processing expense, maintenance and labor. In general, the lower the viscosity of the cocoa liquor, the better the rheological properties in the chocolate, with minimal fat content.

Through use of modern classification mills, particle size distribution can be tightly controlled, resulting in cocoa powder that has very few particles greater than a desired cut-off, such as, without limitation, 75, 50, 40 or 25 μm, to produce a chocolate liquor having a dispersible solids component that has acceptable mouth-feel. The reduction in the amount of extra-fine particles has the added effect of lower viscosity of the resultant chocolate liquor and other processing difficulties associated with the presence of too-fine particles, such as agglomeration when mixing. Indeed, the goal of the refining process, for example on a five-roll roller, is to bring the size distribution of solids within a cocoa-containing product to within an acceptable range, for example and without limitation, in a range from about 15 μm to about 75 μm. Thus, if solids in chocolate liquor or in a cocoa-containing composition can be reduced to a desired post-refining size distribution without using a roller device, the costs of producing cocoa-containing compositions can be reduced. Processing of cocoa beans in a classification mill, as described herein, therefore, is uniquely able to produce particle sizes of from about 15 μm to about 25-75 μm, including all integers or fractions therebetween, for example and without limitation from about 15 μm to about 25, 30, 40, 50 or 75 μm.

Further, by cryogenically processing cocoa beans in a single step, multiple steps of the cocoa grinding process, such as stone and ball milling, can be avoided, with further reductions in cost and maintenance. Removal of a ball mill from the processing system has the added effect of reducing iron content in the resultant chocolate liquor or other cocoa-containing composition.

In addition to the above, solid ingredients other than cocoa beans or portions thereof can be cryogenically comminuted in a classification mill. For example and without limitation, in the preparation of dark chocolate, cocoa beans and sugar can be co-comminuted with the cocoa beans or portions thereof, resulting in a product that does not need roller-refining. Refining, for example roller refining, aside from assuring proper size-distribution of solids, has the added effect of blending flavors. Because roller-refining to adjust the size distribution of solids is not always necessary, any mixing device, such as a mixer, can be used to mix the comminuted product and other ingredients, such as, without limitation: flavorings, liquids, fragrances, sweeteners, colorings, rheology modifiers, larger solids, such as nuts, toffee, oils, surfactants, emulsifiers, vitamins, etc. The only limitation on the additional ingredient(s) that can be added to the classification mill is that the ingredient(s) are comminutable under the classification conditions. The products can even be mixed directly in a conche, which, given the optimal starting solids size distribution produced by the classification mill, will ensure that any chocolate or other cocoa-containing product produced by the methods described herein has the appropriate “mouth-feel” if it has not been achieved prior to conching.

Provided therefore, are methods of making a cocoa-containing composition comprising comminuting cocoa beans or portions thereof at a comminution temperature below an average melting temperature of cocoa butter in the cocoa beans or portions thereof. In non-limiting examples, the comminution temperature is below 23° C., 15° C. or −20° C. In another non-limiting embodiment, the comminution is performed in a classification mill that is cooled with liquid nitrogen. In another variation, the classification mill is cooled by one or more of dry ice (solid CO₂) or liquid CO₂, or by housing within a room, container or other space in which ambient temperature is sufficiently low to maintain an adequately low comminution temperature.

Cocoa beans, as well as any other solids fed into the classification mill are comminuted to a useful size distribution to produce a cocoa-containing composition. In a typical, non-limiting example, the cocoa-containing composition has a fineness at about 75 μm of at least about 99% wt., 99.5% wt., or 99.75% wt. This means, as discussed herein and without limitation, that no more than about 1% wt., 0.5% wt. or 0.25% wt., respectively, of particles are able to pass through a 75 μm opening. According to one embodiment, the mean particle size in the cocoa-containing composition, deduced according to any acceptable method, is less than about 40 μm and, optionally, between about 15 μm and 40 μm. In another non-limiting embodiment, the mean particle size is about 20 μm. In yet another embodiment, the fineness of the cocoa-containing composition in a range from about 10 μm to about 20 μm, including all integers therebetween, is less than about 25% wt., 20% wt., 10% wt., 5% wt., 2.5% wt. or 1% wt., meaning the predominant portion of particles, for example and without limitation, will not pass through a 10 μm or 20 μm opening.

Also described herein are systems for producing a cocoa-containing composition from cocoa beans comprising a comminution means maintained at a temperature at which cocoa butter in cocoa beans is solid. A comminution means is “maintained at a specific temperature” if, during processing of beans, and optionally additional ingredients, the temperature is kept at the specific temperature, plus or minus acceptable variations. For instance, the temperature at any time during comminution and/or other processing steps does not rise above a temperature at which cocoa butter in cocoa beans/chocolate liquor melts or any other solids within the composition to be comminuted melts or is otherwise not processable. An apparatus is “configured into a system” if it is part of a process line and is upstream or downstream in a process line from other members of a process line or system. Apparatus configured into a system are connected in an appropriate manner by a path within the system, which can be, without limitation a pipe, tube, trough, conveyor, belt, baskets, pneumatics, or any other means and/or mechanism by which a composition or item of manufacturer is transferred from apparatus to apparatus in a process line.

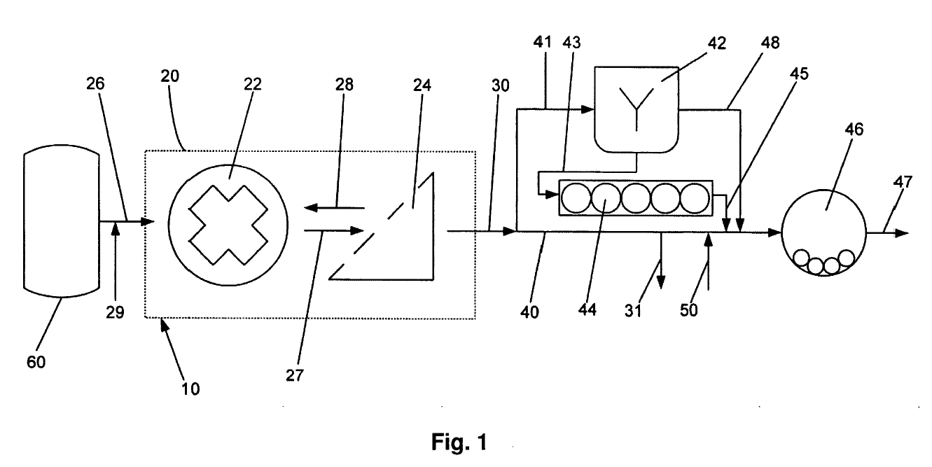

FIG. 1 is a schematic diagram of one non-limiting embodiment of a system for production of a cocoa-containing composition. System 10 comprises a means for comminution, such as classification mill 20, which comprises hammer mill 22 and classifier 24 and which are integrated in any useful manner to permit simultaneous comminution and classification, for example as described herein. Cocoa beans and, optionally, other ingredients, such as sugar and/or cocoa butter (solid) are introduced into classification mill 20 via path 26. Hammer mill 22 and classifier 24 are integrated, such that product pulverized by hammer mill 22 is transferred to classifier 24 via path 27. Pulverized product too large to pass through classifier 24 is transferred back to hammer mill 22 via path 28 for further comminution. Classifier mill 20 is cooled to a temperature such that the comminution temperature of cocoa beans within the mill is below the melting temperature of cocoa butter in cocoa beans. In one embodiment this is achieved by feeding liquid nitrogen or dry ice into the classification mill 20.

As used in FIG. 1, all arrows which reference paths, inlets or outlets may comprise any useful means and/or mechanism by which the indicated product can be transferred from apparatus-to-apparatus, including, without limitation, a pipe, trough, conveyor, belt, basket, pneumatics, or any other means or mechanism by which a composition or item of manufacturer is transferred from apparatus to apparatus in a process line. A path may be a gap or space between one device from another, such as in the case of a hammer or pin mill being located within the same housing as a classifier wheel within a body of a classification mill.

Particles smaller than a threshold size limit for classifier 24, can be transferred through path 30 for downstream processing. FIG. 1 shows a number of options. In a first option, cocoa-containing product is transported from system 10 via path 31 for direct packaging or use in any of a number of processes and/or recipes (not shown), for example at a temperature at which the product remains a solid. According to a second embodiment, the cocoa-containing product from the classification mill 20 can be transferred via path 41 to mixer 42, and where the cocoa-containing product can be combined with additional ingredients. Depending on the nature of those ingredients, solids may be present, requiring refining in, for example, a five-roller refiner, as is common in the chocolate-making industry. As is shown, the product can be transferred from mixer 42 via path 43 to five-roller refiner 44 and then via path 45 to conche 46. Product of conche 46 is transferred to additional processing steps via path 47. If the product of mixer 42 does not need refining, it may be transferred directly to conche 46 via path 48.

In yet another example, cocoa-containing product produced by the classification mill may be transferred into conche 46, bypassing mixer 42 and/or roller-refiner 44. In that case, ingredients, such as dried milk and sugar can be fed into classification mill 20 and the product of classification mill 20 can be sent to conche 46 directly.

It should be recognized that the system shown in FIG. 1 is schematic in nature and shows an exemplary number of apparatuses within system 10. Other apparatuses, feed paths, outlet paths, etc. can be added to this system at any point in the process to achieve a goal in addition to that described. For example and without limitation, an inlet 50 and/or 29 may be provided for feeding cocoa butter to the mixer or any of paths 30, 40, 41, 43, 45 and 48. In another non-limiting example, a cooler 60 (for example and without limitation, a nib cooler) is placed upstream of the classification mill to pre-cool the cocoa beans and, optionally, additional ingredients, below a temperature at which cocoa butter melts in cocoa beans. Cooler 60 can be a hopper, optionally including a mixer, or other storage facility in which solids such as cocoa beans can be cooled by refrigeration or contact with cold materials, such as dry ice, liquid CO₂ or liquid nitrogen.

Variations of system 10 and apparatus and sub-processes thereof would be apparent to those of ordinary skill in the art and are considered to be within the scope of the disclosure provided herein.

Because the processes described herein remove the need for use of a ball-mill, as well as other processing steps, the cocoa-containing composition product of the process is seen to typically have lower iron levels as compared to typical equivalent products currently available commercially. Provided therefore is a low-iron cocoa-containing composition prepared according to a process comprising comminuting cocoa beans at a comminution temperature which is lower than a melting temperature of cocoa butter in the cocoa beans. The cocoa-containing product typically has an iron content that is lower than a cocoa-containing composition comprising equivalent ingredients (for example cocoa beans from the same commercial lot of beans) produced by a process that uses a ball mill; in one example 50% lower, and in additional examples from about 50% to about 70% lower, including all integers therebetween.

In one non-limiting example, the cocoa-containing composition is a chocolate liquor having an iron content of less than about 200 ppm. In another non-limiting example, the cocoa-containing composition is a chocolate liquor having an iron content of less than about 175 ppm. In another non-limiting example, the cocoa-containing composition is a chocolate liquor having an iron content of less than about 150 ppm. Cocoa powders and cocoa butters with equivalently-reduced amounts of iron also are provided. The cocoa-containing composition can be a chocolate liquor that comprises additional cocoa powder, sugar, non-nutritive sweetener, additional solid cocoa butter, flavorings, liquids, fragrances, sweeteners, colorings, rheology modifiers, solidified oils, surfactants, emulsifiers, and vitamins, so long as the additional ingredient(s) in the composition are comminutable and classifiable. Also provided is a cocoa-containing composition that comprises one or more of: a chocolate liquor having an iron content of less than about 200 ppm; a cocoa powder having an iron content of less than about 450 ppm; and a cocoa butter having an iron content of less than about 0.4 ppm. In yet another non-limiting example, a cocoa-containing composition is provided, in which the composition comprises particles of comminuted cocoa beans at a temperature below a melting temperature of cocoa butter in the cocoa beans, the particles having a mean particle size in a range of from about 20 μm to about 40 μm, a fineness at 75 μm of at least about 99% wt., 99.5% wt., 99.6% wt. or 99.75% wt, a coarseness in a range from about 10 μm to about 20 μm, including all integers therebetween, greater than about 75% wt., 80% wt., 90% wt., 95% wt., 97.5% wt. or 99% wt.

In a further embodiment, cocoa nibs may be cooled with liquid nitrogen after roasting. Cooled cocoa nibs can be comminuted with a classifier mill, where the comminution temperature is 15° C. or less. As 15° C. is lower than the lowest typical melting temperature of cocoa butter in cocoa nibs, the chocolate liquor will be in powder form. With the use of a classifier mill, the end fineness can be set to a value of 99.6%, where 99.6% by mass of the particles will be smaller than 75 μm. By using a single classifier mill rather than a standard series of mills, such as a Lehmann three stone mill and two ball mills, the chocolate liquor obtained by a single classifier mill can have significantly lower iron content than chocolate liquor obtained by the series of mills.

The storage and packaging of chocolate liquor in powder form can be easier than chocolate liquor in liquid form. The chocolate liquor in powder form can be stored in silos, packed in 25 kg or 50 lbs paper bags, filled in bulk containers, or even be transported in bulk tank that are pneumatically filled and emptied

Typically, cross-contamination occurs due to chocolate liquor from previous batches being left behind within the storage silos. Cross-contamination can result in products that are out of specification, such as specification for color or composition. Ease of handling the powder form of the chocolate liquor can reduce cross-contamination between different batches of chocolate liquor. After emptying a storage silo containing chocolate liquor in powder form, less of the product remains than after emptying a silo containing chocolate liquor in liquid form.

The chocolate liquor described herein can be mixed with cocoa powder to increase the fat content of cocoa powder, reduce the iron content of the powder or otherwise change the composition, flavor and/or color of a cocoa powder. For example and without limitation, commercial cocoa powder (10-12% fats) can be mixed with suitable amounts of a powdered liquor prepared by a process described herein to make, for example and without limitation, a 16/18% (fats) or a 22/24% cocoa product. In yet another non-limiting example, cocoa powder that is out of commercial specifications (specifications for, for example and without limitation, 16/18% or 22/24% cocoa powder) can be corrected by mixing the out-of-specification product with suitable amounts of powdered liquor prepared by a process described herein.

### EXAMPLE 1

### Method of Decreasing Iron Content of Cocoa Liquor by Cryogenic Comminution of Cocoa Nibs

Typical iron (Fe) content in chocolate liquor prepared by common commercial processes is about 250 ppm. Using the processes described herein, the Fe levels are significantly lower than 250 ppm. In addition, the metallic iron content was very low, between 1 to 9 ppm (see, Tables 1 and 2, below). The parameters of each of the tests are summarized in Table 1 and are described more fully in the following examples.

### EXAMPLE 2

### Method of Producing Chocolate Liquor by Comminution at −30° C.

Cocoa nibs were pre-cooled with liquid nitrogen to −30° C. The feeding of the cooled cocoa nibs was controlled by using a funnel and an rpm-controlled air lock. Grinding of the cooled cocoa nibs was performed within a Hosokawa classifier mill type ACM10, with the grinding disk at 5800 rpm and classifier at 2000 rpm. The grinding disc had 4 hammers (tungsten). During grinding, liquid nitrogen was injected into the air feed of the mill. Both a cyclone and filter was used to separate the gas from the comminuted product.

The feed capacity was 54.5 kg/h and the temperature of product at the outlet was about −15.5° C. Test 1 and test 2 were conducted with the same parameters. The sieve residues were as follows:

| | Sieve residue | | |
|---|---|---|---|
| | 75μ | 125μ | 250μ |
| Test 1 | 13.87% | 7.82% | 2.45% |
| Test 2 | 14.17% | 8.49% | 2.11% |

### EXAMPLE 3

### Method of Producing Chocolate Liquor by Comminution at 15° C. with Higher Feed Capacities

Cocoa nibs were fed into the mill as described in Example 2, without pre cooling. The temperature of the nibs was about 15° C. The feeding of the cocoa nibs was controlled by using a funnel and an rpm-controlled air lock. Grinding was performed within a Hosokawa classifier mill type ACM10, with the grinding disk at 5500 rpm and classifier at 2000 rpm. The grinding disc had 4 hammers (tungsten). During grinding, liquid nitrogen was injected into the air feed of the mill. Both a cyclone and filter was used to separate the gas from the comminuted product.

The feed capacity was 128 kg/h (test 3), 225 kg/h (test 4) and 450 kg/h (test 5). Higher feed capacities higher than about 900 kg/h (test 6) led to a blocked mill. The sieve residues were:

| | Sieve residue | | |
|---|---|---|---|
| | 75μ | 125μ | 250μ |
| Test 3 | 17.22% | 13.17% | 5.19% |
| Test 4 | 21.28% | 18.55% | 10.32% |
| Test 5 | 27.24% | 24.50% | 16.85% |

### EXAMPLE 4

### Method of Producing Chocolate Liquor by Comminution at 15° C. with Higher Grinding Disk Speed

Cocoa nibs were fed into the mill as described in Example 2, without pre-cooling. The temperature of the nibs was about 15° C. The feeding of the cocoa nibs was controlled by using a funnel and an rpm-controlled air lock. Grinding was performed within a Hosokawa classifier mill type ACM10. The grinding disc had 4 hammers (tungsten). During grinding, liquid nitrogen was injected into the air feed of the mill. Both a cyclone and filter was used to separate the gas from the comminuted product.

The feed capacity was 81 kg/h. In test 7, the grinding disk speed was 6000 rpm, with the classifier speed at 3500 rpm. In test 8, the grinding disk speed was increased to 6600 rpm, with the classifier speed at 3500 rpm. The higher grinding disk speed and classifier speed in combination with the decreased feed capacity produced a less coarse end product, as evidenced by the sieve residues:

| | Sieve residue | | |
|---|---|---|---|
| | 75μ | 125μ | 250μ |
| Test 7 | 2.89% | 0.53% | 0.09% |
| Test 8 | 0.93% | 0.22% | 0.02% |

### EXAMPLE 5

### Method of Producing Chocolate Liquor by Comminution at 15° C. with Different Grinding Disks

Cocoa nibs were fed into the mill without pre cooling as described in Example 2. The temperature of the nibs were about 15° C. The feeding of the cocoa nibs was controlled by using a funnel and an rpm-controlled air lock. Grinding was performed within a Hosokawa classifier mill type ACM10, with the grinding disk at 6000 rpm and classifier at 3500 rpm. During grinding, liquid nitrogen was injected into the air feed of the mill. Both a cyclone and filter were used to separate the gas from the comminuted product. Comminution was conducted with either a grinding disc with 12 hammers (test 9) or a grinding disk with 16 pins (test 10). Both examples led to blocking of the mills.

### EXAMPLE 6

### Method of Producing Chocolate Liquor by Comminution at 15° C. with Higher Classifier Speed

Cocoa nibs were fed into the mill without pre-cooling as described in Example 2. The temperature of the nibs was about 15° C. The feeding of the cocoa nibs was controlled by using a funnel and an rpm-controlled air lock, where the feed capacity was 60 kg/h. Grinding was performed within a Hosokawa classifier mill type ACM10, with the grinding disk at 6600 rpm and classifier at 4000 rpm. The grinding disc had 4 hammers (tungsten). During grinding, liquid nitrogen was injected into the air feed of the mill. Both a cyclone and filter were used to separate the gas from the comminuted product.

When the classifier speed was increased to 4000 rpm (test 11), the result was a very fine product, which melted into liquor when heated. Sieve residue was comparable with the specification of liquor ground by a combination of stone and ball mills in a traditional manner.

| | Sieve residue | | |
|---|---|---|---|
| | 75μ | 125μ | 250μ |
| Traditional liquor | 0.40% | 0.10% | 0.03% |
| Test 11: sample 1 | 0.05% | 0.01% | 0.00% |
| Test 11: sample 2 | 0.04% | 0.01 | 0.00% |

The liquor formed from the melted powder was thixotropic, which was caused by the high moisture content of about 10%. The high moisture content comes from the air which is used for the transport of the product into the mill, where the moisture in this air condenses on the product because of the extreme low temperatures.

### EXAMPLE 8

### Method of Producing Chocolate Liquor by Comminution with Dry Ice

Cocoa nibs were fed into the mill with dry ice (CO₂ pellets at −78° C.), where the temperature of the nibs and the dry ice were about −70° C. The mixture included 30 kg of cocoa nibs and 20 kg of CO₂ pellets. The feeding of the cocoa nibs was controlled by using a funnel and an rpm-controlled air lock. Grinding was performed within a Hosokawa classifier mill type ACM10, with the grinding disk at 6600 rpm and classifier at 3500 rpm. The grinding disc had 4 hammers (tungsten). During grinding, liquid nitrogen was injected into the air feed of the mill. Both a cyclone and filter were used to separate the gas from the comminuted product. The feed capacity was 30 kg/h (test 13). A higher feed capacity than 30 kg/h led to a blocked mill (test 12).

| | Sieve residue | | |
|---|---|---|---|
| | 75μ | 125μ | 250μ |
| Traditional liquor | 0.40% | 0.10% | 0.03% |
| Test 13: sample 1 | 0.36% | 0.02% | 0.00% |
| Test 13: sample 2 | 0.31% | 0.02% | 0.00% |

The analysis results for the first sample from test 2 showed a very high total iron content of 300 ppm. It is assumed that this was caused by Fe residues from former tests. During the tests, the total iron content in the samples became lower. In tests 11 and 13 the total Fe content showed an average value of 135 ppm. The metallic Fe content also was analyzed, yielding very low values of 1 to 9 ppm. The total Fe content of the products produced by the present invention is substantially lower than the 250 ppm in the liquor produced in the traditional wet grinding process.

Just as cocoa nibs were cooled with solid CO₂ pellets (dry ice) or with liquid nitrogen, the cocoa nibs may also be cooled with liquid CO₂. Liquid CO₂ effectively cools the nibs by evaporating directly at the nib's surface. Though the cost per kg of liquid CO₂ can be higher than liquid nitrogen, consumption of liquid CO₂ may be less than that for liquid nitrogen due to liquid CO₂'s higher cooling capacity. The use of liquid CO₂ could also decrease the moisture content of the comminuted nibs. The additional costs of CO₂ expenditure can be balanced with savings on energy and maintenance costs as is required with conventional cocoa nib grinding processes.

Some of the processes described herein use liquid nitrogen, and the cost of the liquid nitrogen impacts the economy of the process. Nevertheless, against the additional costs of nitrogen expenditure there are the savings of this single-step process over traditional methods, including, without limitation savings on energy and maintenance costs of the following equipment: triple stone mills, ball mills, liquor sieves, pumps and cooling during grinding.

TABLE 1
Process Parameters

| Test | Disc | | Mill | Classifier | Product | Capacity | Temp. | | Gas | | |
|---|---|---|---|---|---|---|---|---|---|---|---|
| No.. | type | | rpm | rpm | Type | kg/h | In ° C. | out ° C. | flow m³/min | temp. In ° C. | temp. Out ° C. |
| 1 | 4 | hammer | 5800 | 2000 | N-Nibs | 54.5 | −30 | −15.5 | 15 | −36 | −24 |
| 2 | 4 | hammer | 5800 | 2000 | N-Nibs | 54.5 | −30 | −15.5 | 15 | −38 | −26 |
| 3 | 4 | hammer | 5800 | 2000 | N-Nibs | 128 | 15 | −16.5 | 15 | −36 | −26 |
| 4 | 4 | hammer | 5800 | 2000 | N-Nibs | 225 | 15 | −17 | 15 | −36 | −26 |
| 5 | 4 | hammer | 5800 | 2000 | N-Nibs | 450 | 15 | −18 | 15 | −36 | −26 |
| 6 | 4 | hammer | 5800 | 2000 | N-Nibs | | 15 | | | | |
| 7 | 4 | hammer | 6000 | 3500 | N-Nibs | 81 | 15 | −9 | 15 | −28 | −10 |
| 8 | 4 | hammer | 6600 | 3500 | N-Nibs | 81 | 15 | −9 | 15 | −27 | −10 |
| 9 | 12 | hammer | 6600 | 3500 | N-Nibs | | 15 | | 15 | | |
| 10 | 16 | pins | 6600 | 3500 | N-Nibs | | 15 | | 15 | | |
| 11 | 4 | hammer | 6600 | 4000 | N-Nibs | 60 | 15 | −9 | 15 | −36 | −23 |
| 12 | 4 | hammer | 6600 | 3500 | N-Nibs | | −70 | −6 | 15 | −12 | −9 |
| 13 | 3 | hammer | 6600 | 3500 | N-Nibs | 30 | −70 | −4 | 15 | −17 | −14 |

TABLE 2
Analysis results

| Test | | | Fe | | Sieve residue | | |
|---|---|---|---|---|---|---|---|
| No. | Fat % | Moist % | total ppm | met. ppm | 75μ | 125μ | 250μ |
| 0-1* | | | 68 | | | | |
| 0-2* | | | 49 | | | | |
| 1 | 45 | 15 | 300 | | 13.87 | 7.82 | 2.45 |
| 2 | | | | | 14.17 | 8.49 | 2.11 |
| 3 | | | 180 | | 17.22 | 13.17 | 5.19 |
| 4 | | | 170 | | 21.82 | 18.55 | 10.32 |
| 5 | | | 200 | | 27.74 | 24.50 | 16.85 |
| 6 | | | | | | | |
| 7 | | | 180 | | 2.89 | 0.53 | 0.09 |
| 8 | | | | | 0.93 | 0.22 | 0.02 |
| 11-1 | 51 | 9.4 | 140 | 1 | 0.05 | 0.01 | 0.00 |
| 11-2 | 51 | 9.8 | 150 | 1 | 0.04 | 0.01 | 0.00 |
| 13-1 | 52 | 6.8 | 110 | 2 | 0.36 | 0.02 | 0.00 |
| 13-2 | 52 | 6.8 | 140 | 9 | 0.31 | 0.02 | 0.00 |

*Tests 0-1 and 0-2 refer to control measurements of roasted nibs that were not further comminuted.

Whereas particular embodiments of the one or more inventions described herein have been described above for purposes of illustration, it will be evident to those skilled in the art that numerous variations of the details of those one or more inventions may be made without departing from the embodiments defined in the appended claims.

We claim:

1. A process for producing a cocoa-containing composition, comprising:
comminuting cocoa beans at a temperature below a melting temperature of cocoa butter in the cocoa beans.

2. The process of claim 1, wherein the cocoa beans comprise roasted, alkalized or unroasted whole cocoa beans, shelled cocoa beans, cocoa nibs, cocoa bean shells, cocoa bean embryos, cocoa bean cotyledons or combinations of any thereof.

3. The process of claim 1, further comprising cooling the cocoa beans to a temperature of 15° C. or less.

4. The process of claim 1, wherein comminuting the cocoa beans occurs in a classification mill.

5. The process of claim 1, further comprising mixing the cocoa beans with liquid nitrogen, liquid carbon dioxide, carbon dioxide chips, or combinations of any thereof.

6. A product produced by the process of claim 1.

7. The product of claim 6, having a fineness at 75μ of at least about 99%.

8. The product of claim 6, wherein a mean particle size of the product is less than about 40 μm.

9. The process of claim 1, further comprising mixing the cocoa-containing composition with a cocoa powder, a cocoa butter or a combination thereof.

10. The process of claim 1, further comprising packing and storing the cocoa-containing composition at a temperature below a melting temperature of cocoa butter in the composition.

11. The process of claim 1, further comprising shipping the cocoa-containing composition at a temperature below a melting temperature of cocoa butter in the composition.

12. A system for producing a cocoa-containing composition, comprising:
cocoa beans; and
means for comminuting the cocoa beans at a temperature below a melting temperature of cocoa butter in the cocoa beans.

13. The system of claim 12, wherein the means for comminuting the cocoa beans comprises a classification mill.

14. The system of claim 12, further comprising a cooler configured to cool the cocoa beans before the cocoa beans are fed into the means for comminuting the cocoa beans.

15. The system of claim 14, wherein the cooler comprises liquid nitrogen, liquid carbon dioxide, carbon dioxide chips or combinations of any thereof.

16. The system of claim 12, wherein the means for comminuting the cocoa beans maintains the cocoa beans at a temperature of 15° C. or below.

17. The system of claim 12, wherein components of the system are contained a room maintained at a temperature of 15° C. or below.

18. The system of claim 12, further comprising a conche configured to receive comminuted cocoa beans.

19. The system of claim 18, further comprising:
a mixing vessel, a refining roller or a combination thereof;
wherein the mixing vessel, the refining roller or the combination thereof is configured between the means for comminuting the cocoa beans and the conche.

20. The system of claim 12, further comprising comminuted cocoa beans in a powdered form.

21. The system of claim 20, wherein the comminuted cocoa beans have an iron content of less than 250 ppm.

22. The system of claim 20, wherein the comminuted cocoa beans have a fineness at 75 microns of at least 99%.

23. A chocolate liquor powder comprising:
comminuted cocoa beans;
the chocolate liquor powder having an iron content of less than 250 ppm;
the chocolate liquor powder having a fineness at 75 microns of at least 99%;
the chocolate liquor powder being at a temperature below a melting temperature of cocoa butter in the cocoa beans.

24. The chocolate liquor powder of claim 23, having an iron content of less than 200 ppm.

25. The chocolate liquor powder of claim 23, wherein particles of the chocolate liquid powder have a fineness at 10 microns of greater than about 10%.
